(19) United States
(12) Patent Application Publication
(10) Pub. No.: US 2007/0074931 A1
(43) Pub. Date: Apr. 5, 2007

(54) Ladder balance safety grips

(76) Inventor: George Armondo, Los Angeles, CA (US)

Correspondence Address: George Armondo, 10480 National Blvd., Apt. 117, Los Angeles, CA, 90034, US

(21) Appl. No.: 11/243,663

(22) Filed: Oct. 5, 2005

(51) Int. Cl. E06C 7/18

(52) U.S. Cl. 182/106; 182/129

(57) ABSTRACT

According to OSHA, ladder falls account for over twenty thousand workplace injuries and as many as 36 deaths per year. Many people who use ladders in the home for painting, changing light bulbs, etc . . . describe feeling unbalanced, wobbly, and nervous, especially when standing on A-frame ladders. Many ladder falls occur simply because the user loses his balance on the higher steps. Adding a sturdy grip or rail to the ladder would help users maintain their balance. Users prone to vertigo or unbalance may derive more security from the existence of the safety grip. The invention comprises a sturdy bar attached to the frame of a ladder and extendable above the top of the ladder. The bar is extendable by means of two hollow tubes attached firmly to the frame of the ladder, through which both ends of the bar can slide. A locking mechanism enables the safety bar to be extendable to different heights above the ladder. The safety bar is made of a sturdy material such as metal, plastic, wood, or strong aluminum. This safety attachment can be adapted to all existing ladders currently in use.

### FIELD OF THE INVENTION

The invention relates to ladders and ladder safety.

### BACKGROUND OF THE INVENTION

According to POCONO records, ladder falls account for hundreds of thousands of injuries per year, some of them fatal. Many people who use ladders in the home for painting, changing light bulbs, etc . . . describe feeling unbalanced, wobbly, and nervous, especially when standing on A-frame ladders. Many ladder falls occur simply because the user loses his balance on the higher steps. Adding a sturdy grip or rail to the ladder would help users maintain their balance. Users prone to vertigo or unbalance may derive more security from the existence of the safety grip.

### SUMMARY OF THE INVENTION

The invention comprises a sturdy bar attached to the frame of a ladder and extendable above the top of the ladder. The bar is extendable by means of two hollow tubes attached firmly to the frame of the ladder, through which both ends of the bar can slide. A locking mechanism enables the safety bar to be extendable to different heights above the ladder. The safety bar is made of a sturdy material such as metal, plastic, wood, or strong aluminum. This safety attachment can be adapted to all existing ladders currently in use.

In another embodiment the ladder further comprises a top step with a hole through the middle part of the step, such that the edges of the step also become safety grips for a person climbing the ladder. The hole can further be fitted with a bag or container for tools, paintbrushes, or whatever else the handyman needs, and the bag hangs down under the hole. The embodiment has the added safety benefit of deterring daredevils from attempting to climb on the dangerous top step.

### BRIEF DESCRIPTION OF THE DRAWINGS

FIG. 1a illustrates a standard A-frame ladder with two hollow tubes attached to the frame.

FIG. 1b illustrates an extendable safety bar.

FIG. 2 illustrates the extendable safety bar attached to the frame of the ladder by means of the hollow tubes.

FIG. 3a and 3b illustrate one mechanism by which the safety bar is made extendable.

FIG. 4 illustrates the ladder with a hole in the top step, and a bag is fitted to the hole.

### DETAILED DESCRIPTION

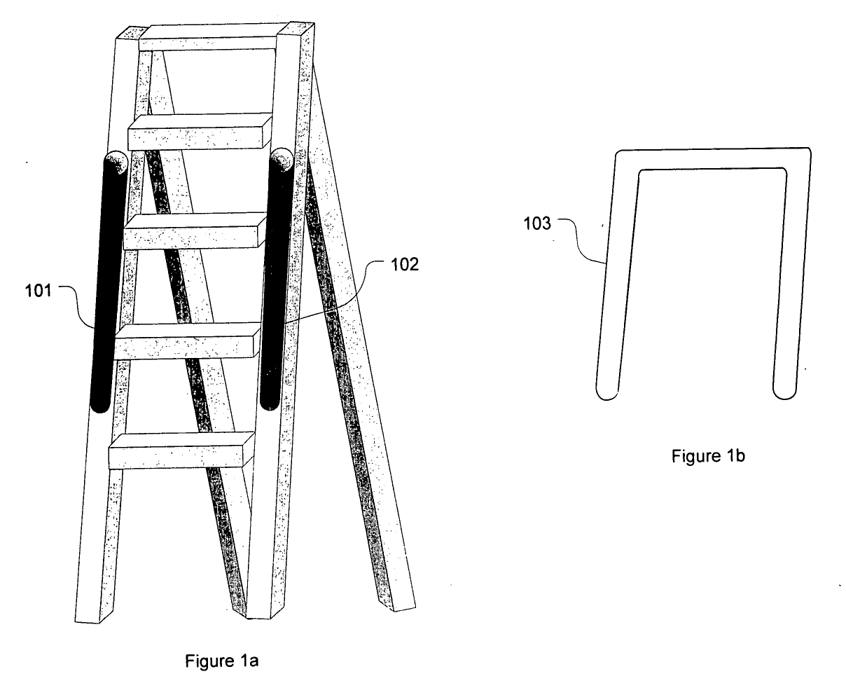

FIG. 1a illustrates a standard A-frame ladder with two hollow tubes 101 and 102 attached to the frame. The hollow tubes are attached firmly to the ladder using nails, screws, or any other strong fastening device. A safety bar 103 pictured in FIG. 1b can be fitted and slid into the hollow tubes. The hollow tubes thus provide a flexible means of attaching the safety bar to the ladder. The safety bar is made of a sturdy material such as metal, plastic, or strong aluminum. By attaching the tubes 101 and 102 to an existing ladder, the safety bar can be adapted to all ladders currently in use.

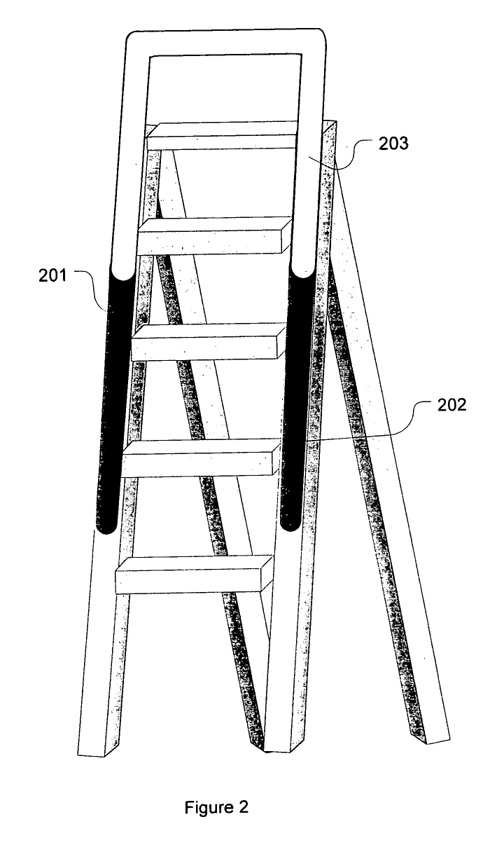

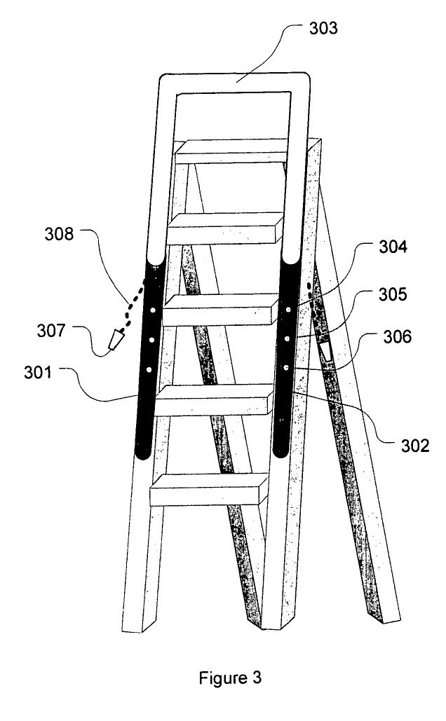

FIG. 2 illustrates the preferred embodiment of the invention, wherein the extendable safety bar 203 attached to the frame of the ladder by means of the hollow tubes 201 and 202. The safety bar provides a means of balance to a ladder user. For example, the user can grip the safety bar to help ascend to the higher steps of the ladder, or to steady himself when reaching a high wall or ceiling, for example during painting or changing a light bulb. The invention also comprises a mechanism by which the safety bar can be extended to different fixed heights above the ladder. FIG. 3 illustrates a simple mechanism for locking the safety bar at different heights above the ladder. As illustrated in FIG. 3, the hollow tube 301 has holes 304, 305, and 306. The safety bar 303 has a hole (not pictured), so that when aligned with one of the holes 304, 305, or 306, a plug 307 can be inserted through the hollow tube and the safety bar to lock the safety bar in place. The holes 304, 305, and 306 are placed at a range of heights so that the user can adjust the height of the safety bar as necessary. The plug 307 can be attached to the ladder by means of a chain 308. This is just one illustration of a simple mechanism that enables the safety bar to be adjustable to different fixed heights above the ladder, but other locking mechanisms for nested tubes may be used to make the safety bar extendable to different fixed heights.

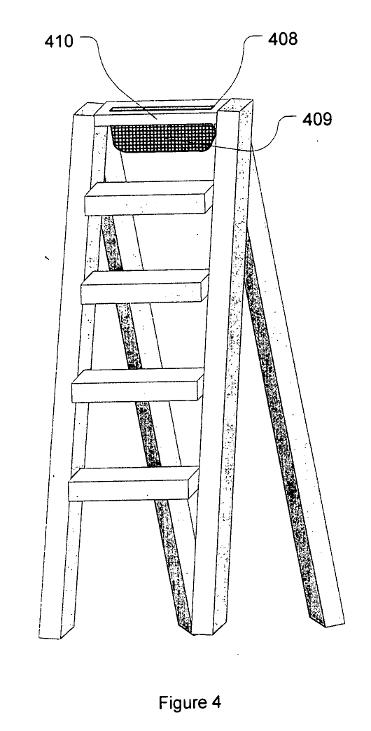

FIG. 4 illustrates a top step 408 with a hole in the middle part and a bag 409 fitted to hang under the hole. The hole in the top step creates a rim 410 for the user to grip when climbing higher on the ladder. The bag can be used to hold handyman's tools or other necessities. Because of the hole, the user cannot step on the top step, further reducing the risk of falls and accidents.

We claim:

1. A ladder safety attachment comprising:
two hollow tubes attached in parallel to two sides of the ladder;
a safety bar attached to the two hollow tubes by means of sliding each end of the safety bar into the two hollow tubes, wherein the safety bar provides a means of balance for a ladder user; and
a locking mechanism whereby the safety bar is extendable to different fixed heights beyond the height of the ladder.

2. The safety ladder of claim 1 wherein the locking mechanism comprises one or more holes in the two hollow tubes and a hole in the safety bar; and a plug that is inserted when one hole in the hollow tube is aligned with the hole in the safety bar.

3. The safety ladder of claim 1 further comprising a top step with a hole; and a container attached to the top step, wherein the container hangs under the hole.
